(19) United States
(12) Patent Application Publication
(10) Pub. No.: US 2018/0052666 A1
(43) Pub. Date: Feb. 22, 2018

(54) Adaptive Recursive User Interface Testing Automation Framework

(71) Applicant: Microsoft Technology Licensing, LLC, Redmond, WA (US)

(72) Inventors: Yu Zhang, Sammamish, WA (US); Michael Joseph Eatherly, Puyallup, WA (US); Xiaojiang Fang, Issaquah, WA (US); Swati Gupta, Kirkland, WA (US); Xiaohui Wang, Redmond, WA (US)

(73) Assignee: Microsoft Technology Licensing, LLC, Redmond, WA (US)

(21) Appl. No.: 15/243,398

(22) Filed: Aug. 22, 2016

(51) Int. Cl. G06F 9/44; G06F 11/36; G06F 3/0484

(52) U.S. Cl. CPC G06F 8/38; G06F 3/0484; G06F 11/3668

(57) ABSTRACT

Described herein are various technologies pertaining to an adaptive recursive user interface testing automation framework. A workflow used to test a user interface of an application can be automatically adaptively modified. Updating of the workflow can disable testing of element(s) not included in the user interface (e.g., element(s) removed from the user interface), adding testing of element(s) included in the user interface (e.g., element(s) added to the user interface) and/or modifying testing of element(s) of the UI (e.g., element(s) modified in the user interface).

### BACKGROUND

Many computer applications utilize user interfaces (UIs) to allow users to interact with the applications. These UIs can include content items, for example, functionality buttons and controls, text boxes, icons, command bars, toolbars, menus, dialog boxes, along with configurable properties including user interface element size, location, color and the like. During development of the UIs, the UIs can be tested using testing code executing on a testing system to confirm that the control operate as expected. For example, to confirm that entered parameter(s) are within a defined range and/or that application control flow is appropriate based on particular input(s).

Conventionally, when a particular UI is modified, the testing code is manually modified to reflect modifications in the particular UI. However, a single code change directed to one instance of the UI may affect many other instances of the UI. Keeping the testing code synchronized to reflect modifications in the UI can thus be a daunting task.

### SUMMARY

Described herein is a system and method for adapting a workflow for testing of a user interface of an application under test. The system and method can automatically adaptively modify a workflow to test a user interface (“UI”) of an application under test (“AUT”). For example, updating of the workflow can disable testing of element(s) not included in the UI (e.g., element(s) removed from the UI), adding testing of element(s) included in the UI (e.g., element(s) added to the UI) and/or modifying testing of element(s) of the UI (e.g., element(s) modified in the UI). Further, for hierarchically organized element(s), test step(s) for child element(s) can be recursively added to the workflow and/or executed.

The system includes a playback engine component that includes an initialization component that loads the workflow associated with an application under test, parses the workflow for parameter(s), sets environment variable(s) and loads the application under test. Thereafter, a test component of the playback engine component can identify a list of test cases from the workflow and commence iterating through each of the test cases identified. A particular test case can exercise one of more control(s) of the UI associated with the application under test.

For test case(s) for which adaptive ability is desired, the playback engine component adapts the workflow, if necessary, using an adaptive component. By comparing identified element(s) of the application under to test to UI element(s) set forth in the workflow, the adaptive component can adaptively update the workflow to the application under test (e.g., current version of UI). For example, updating of the workflow can disable testing of element(s) not included in the UI (e.g., element(s) removed from the UI), adding testing of element(s) included in the UI (e.g., element(s) added to the UI) and/or modifying testing of element(s) of the UI (e.g., element(s) modified in the UI).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for adapting a workflow for testing of a user interface of an application under test.

FIG. 2 illustrates is an exemplary methodology of adapting a workflow for testing of a user interface of an application under test.

FIG. 3 illustrates is an exemplary methodology of adapting a workflow for testing of a user interface of an application under test.

FIG. 4 illustrates is an exemplary methodology of adapting a workflow for testing of a user interface of an application under test.

FIG. 5 illustrates is an exemplary methodology of adapting a workflow for testing of a user interface of an application under test.

FIG. 6 further illustrates the exemplary methodology of FIG. 5.

FIG. 7 is a functional block diagram that illustrates an exemplary computing system.

### DETAILED DESCRIPTION

Various technologies pertaining to an adaptive recursive user interface testing automation framework are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding an adaptive recursive user interface testing automation framework. What follows are one or more exemplary systems and methods.

Aspects of the subject disclosure pertain to the technical problem of updating testing of user interface(s) of an application under test to reflect modification(s) to the application under test. The technical features associated with addressing this problem involve determining user interface element(s) present in a workflow configured to test the user interface of an application under test which are not available in the user interface of the application under test. Based on the determination, test step(s) associated are disabled and the workflow is adaptively updated accordingly. User interface element(s) of the application under test which are not present in the workflow can further be identified. Based upon this identification, test step(s) can be automatically added to the workflow. Further, for hierarchically organized element(s), child element(s) can be recursively added and/or executed. Accordingly, aspects of these technical features exhibit technical effects of automatically, recursively adapting a workflow to test user interface(s) of the application under test (e.g., to reflect modification(s) to the application under test) thus improving accuracy and speed with which user interface(s) can be tested.

Described herein are various technologies pertaining to an adaptive recursive user interface testing automation framework. A workflow used to test a user interface of an application can be automatically adaptively modified. Updating of the workflow can disable testing of element(s) not included in the UI (e.g., element(s) removed from the UI), adding testing of element(s) included in the UI (e.g., element(s) added to the UI) and/or modifying testing of element(s) of the UI (e.g., element(s) modified in the UI).

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

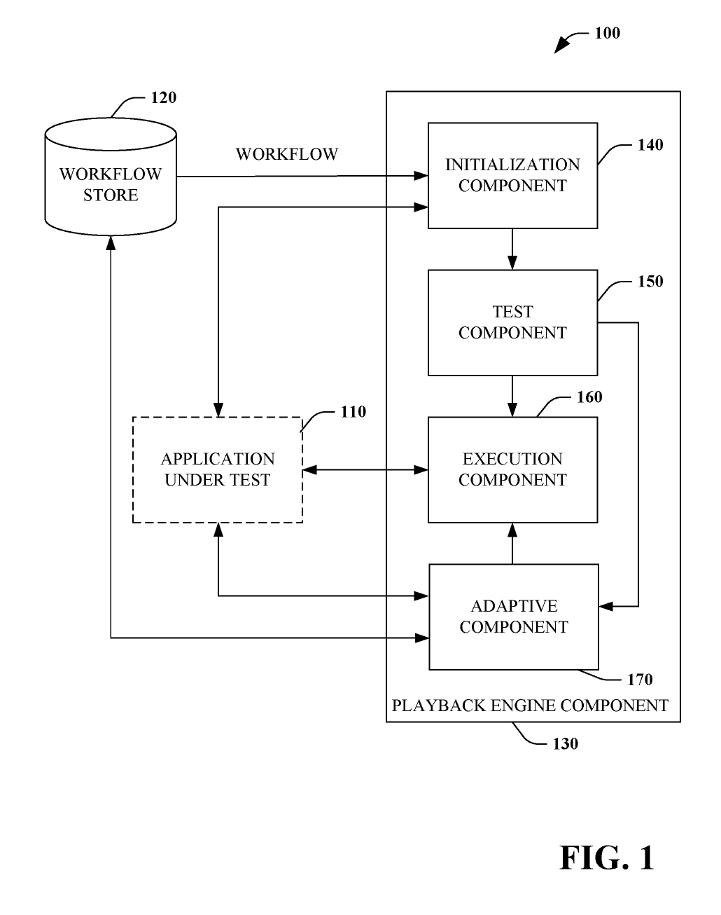

Referring to FIG. 1, a system for adapting a workflow for testing of a user interface of an application under test 100 is illustrated. The system 100 can automatically adaptively modify a workflow to test a user interface (“UI”) of an application under test (“AUT”) 110. For example, updating of the workflow can disable testing of element(s) not included in the UI (e.g., element(s) removed from the UI), adding testing of element(s) included in the UI (e.g., element(s) added to the UI) and/or modifying testing of element(s) of the UI (e.g., element(s) modified in the UI). Further, for hierarchically organized element(s), child element(s) can be recursively added to the workflow and/or executed.

The system 100 can include a workflow store 120 that stores one or more workflow(s) each of which defines instructions for testing of a UI of an application under test 110. In one example, a workflow comprises an XML, file. An example of a workflow is set forth in Table 1:

TABLE 1
<?xml version=“1.0” encoding=“utf-8”?>
<Workflows>

<Workflow Product=“MailClient” TestOwner=“TesterA”>

<GlobalParams>

| | |
|---|---|
| <Param Name=‘CaptureEnable’ | Value=‘true’ /> |

| | |
|---|---|
| <Param Name=‘Platform’ | Value=‘Desktop’ /> |

| | |
|---|---|
| <Param Name=‘BuildNumber’ | Value=‘10210.101’/> |

| | |
|---|---|
| <Param Name=‘Language’ | Value=‘ja-JP’/> |
| <!--<Param Name=‘others’ | Value=‘others’/>--> |

</GlobalParams>
<Configs>

<Config Type=‘RegistryUpdate’ Action=‘Add’>

| | |
|---|---|
| <Param Name=‘File’ | Value =‘.\updateonekey.reg’ /> |

</Config>
<Config Type=‘MSAccount’ Action=‘Signin’>

| | |
|---|---|
| <Param Name=‘Account’ | Value =‘xxx@hotmail.com’ /> |

</Config>
<!--<Config Type=‘others’ Action=‘others’>

| | |
|---|---|
| <Param Name=‘others’ | Value =‘others’ /> |

</Config>-->

</Configs>
<Tests>

<Test>

<AppStart>

| | |
|---|---|
| <Param Name=‘Type’ | Value =‘Executable’ /> |
| <Param Name=‘App’ | Value =‘Mail.exe’ /> |

<Param Name=‘TagetWindows’

Value=‘windowscommunicationsapps’/>

| | |
|---|---|
| <!--<Param Name=‘Others’ | Value=‘Others’/>--> |

</AppStart>
<TESTCASE TestCase=“Check the Mails”>

<!-- Go home page-->
<STEP step=“Go to Homepage” function=“CLICK” Capture=“Yes”>

<TargetUIElement AutomationID=“mailhome”

ClassName=“GridTileElement” />

</STEP>
<Group adaptive=‘true’

adaptivegroup=‘AutoID:Folders;Name=Folders;ClassName:FavariteViewList’
recursivelevel =‘1’
recursivescope=‘AutoID:MailListControl;ClassName:List;Name:’ >

<!-- 0: Predefined Test Steps and SubSteps-->
<STEP step=“Check Inbox” function=“ClICK” Capture=“No”

returnaction=“Action:Click;AutoID:mailhome”>

<TargetUIElement AutomationID=“InboxFolder”

ClassName=“MenuItem” Name=“Inbox” WindowName=“Inbox - Outlook -
Mail”/>

<SubSTEP step=“Open the first mail” function=“Click”

Capture=“Yes” returnaction=“”>

<TargetUIElement AutomationID=“mailList”

ClassName=“ListItem” Name=“” Index=“0” />

</SubSTEP>
<SubSTEP step=“Open the Second mail” function=“Click”

Capture=“Yes” returnaction=“Action:Click;AutoID:mailhome”>

<TargetUIElement AutomationID=“mailList”

ClassName=“ListItem” Name=“” Index=“1”/>

</SubSTEP>

</STEP>
<!-- 1: Predefined Test Steps and SubSteps-->
<STEP step=“Check Sent” function=“CLICK” Capture=“”

returnaction=“Action:Click;AutoID:mailhome”>

<TargetUIElement AutomationID=“InboxFolder”

ClassName=“MenuItem” Name=“Inbox” WindowName=“Inbox - Outlook -
Sent”/>

<SubSTEP step=“Open the first Sent mail” function=“Click”

Capture=“Yes” returnaction=“Action:Click;AutoID:mailhom”>

<TargetUIElement AutomationID=“SentMailList”

ClassName=“ListItem” Name=“” Index=“0” />

</SubSTEP>

</STEP>
<!-- 2: self discovered Test Steps and SubSteps-->
<STEP step=“Check Drafts” function=“CLICK” Capture=“”

returnaction=“Action:Click;AutoID:mailhome”>

<TargetUIElement AutomationID=“DraftsFolder”

ClassName=“MenuItem” Name=“Inbox” WindowName=“Inbox - Outlook -
Drafts”/>

<!-- Recursive sub Steps discovered automatically-->
<SubSTEP step=“Step101” function=“Click” Capture=“Yes”

returnaction=“”>

<TargetUIElement AutomationID=“DraftMailList”

ClassName=“ListItem” Name=“” Index=“0” />

</SubSTEP>

</STEP>

</Group>
<!-- Close the App, testing is done-->
<STEP step=“Exit Mail” function=“CLICK” Capture=“”>

<TargetUIElement AutomationID=“DraftMailList”

ClassName=“ListItem” Name=“” Index=“1” WindowName=“Inbox - Outlook
- Mail”/>

</STEP>

</TESTCASE>

</Test>

</Tests>

</Workflow>

</Workflows>

With reference to Table 1, the workflow can include workflow file information such as “Workflow Product” and “TestOwner” which can be identified when the workflow is parsed. The workflow can further include parameters such as “CaptureEnable”and environment(s), for example, “Config Type”. The workflow can further include test case(s) having step(s). These test case(s) and/or step(s) can be authored and/or be based on adaptively identified UI element(s) present in a user interface of an application under test (e.g., self-discover Test Steps and substeps of Table 1). Further, for hierarchically organized UI element(s), child element(s) can be recursively added (e.g., recursive sub steps discovered automatically of Table 1) and/or executed.

Referring back to FIG. 1, the system 100 can further include a playback engine component 130 that is configured to load a workflow, parse the workflow for parameter(s) of test step(s), set environment(s), launch the application under test and/or execute test case(s) as defined by the workflow.

The playback engine component 130 can include an initialization component 140 that loads the workflow associated with an application under test. The initialization component 140 can retrieve the workflow from the workflow store 120. The initialization component can further parse the workflow for parameter(s) to be utilized during testing. For example, the parameter(s) can include global parameter(s), configuration parameter(s) and parameter(s) associated with the application under test (e.g., type, name, etc.). The initialization component 140 can further set environment variable(s) and otherwise set up a testing computer (e.g., executing the system 100).

Once the workflow has been loaded and initialized, the application under test 110 can be launched by the initialization component 140. Thereafter, a test component 150 of the playback engine component 130 can identify a list of test cases from the workflow and commence iterating through each of the test cases identified. For example, a particular test case can exercise one of more control(s) of the UI associated with the application under test 110.

In one example, an ability to adapt the workflow to a UI of an application under test 110 is selectable (e.g., based on a user setting). The ability to adapt can be specified, for example, in the workflow at a high level (e.g., a group of UI element(s)) and/or at a granular level (e.g., relative to a specific UI element).

For test case(s) for which adaptive ability is not desired, the playback engine component 130 executes the particular test case using an execution component 160 and proceeds to iterate through to the next test case, if any. For test case(s) for which adaptive ability is desired, the playback engine component 130 adapts the workflow, if necessary, using the adaptive component 170. In one example, the execution component 160 can execute the test case by providing command(s) and/or parameter(s) to application programming interface(s) (APIs) of the application under test and receiving result(s) via APIs of the application under test.

The adaptive component 170 can adaptively update the workflow to the application under test 110 (e.g., current version of UI). For example, updating of the workflow can disable testing of element(s) not included in the UI (e.g., element(s) removed from the UI), adding testing of element(s) included in the UI (e.g., element(s) added to the UI) and/or modifying testing of element(s) of the UI (e.g., element(s) modified in the UI).

In order to determine element(s) of the UI, the adaptive component 170 can obtain information regarding UI element(s) of the application under test 110. In one example, the application under test 110 can expose UI element(s) and their property(ies) through the use of APIs. In this example, using APIs of the application under test 110, the adaptive component 170 can identify element(s) of the UI. In one example, again using APIs of the application under test 110, the adaptive component 170 can identify property(ies) of identified element(s) of the UI.

The adaptive component 170 can compare the identified element(s) to UI element(s) set forth in the workflow. If a UI element is specified in the workflow, but not identified in the UI element(s) obtained from the application under test 110, the adaptive component 170 can determine that the UI element specified in the workflow is not available for testing (e.g., UI element(s) removed from the UI). Accordingly, the adaptive component 170 can disable step(s) in the workflow of the test case associated with testing of the particular UI element of the application under test 110.

Next, based upon comparison of the identified element(s) to UI element(s) set forth in the workflow, if a UI element specified in the workflow is identified in the UI element(s) obtained from the application under test 110, the execution component 160 can execute step(s) of the test case associated with testing of the particular UI element.

Finally, based upon comparison of the identified element(s) to UI element(s) set forth in the workflow, if a UI element identified in the UI element(s) obtained from the application under test 110 is not specified in the workflow (e.g., element(s) added to the UI), the adaptive component 170 can automatically add step(s) in the workflow to the test case in order to test the particular UI element(s).

In one example, these automatically added step(s) can be based upon the identified property(ies) associated with the UI element provided by the application under test 110. For example, one of the identified properties can identify a “type” associated with the UI element. Based on the identified type, testing step(s) can be identified and utilized to test the UI element. Similarly, identified property(ies) can used to identify and parameter(s) for testing of the UI element. Further, for hierarchically organized element(s), test step(s) for child element(s) can be recursively added to the workflow and/or executed.

In one example, the adaptive component 170 can further determine modification of UI element(s), based upon a comparison of the identified element(s) to UI element(s) set forth in the workflow. Based upon this determination, step(s) of the test case can automatically be modified.

The system 100 has been explained with adapting of a workflow while executing the workflow. However, those skilled in the art will recognize that the subject disclosure is not limited to that scenario. In accordance with the subject disclosure, a workflow can be adapted at one time and at a later time, the adapted workflow executed.

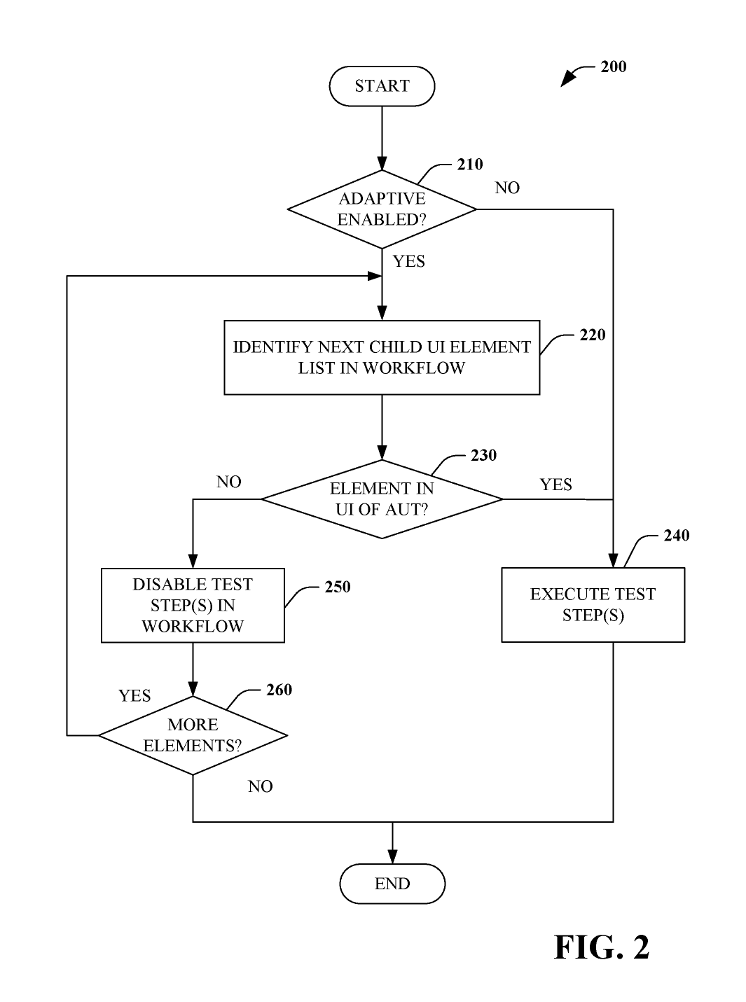

FIGS. 2-6 illustrate exemplary methodologies relating to adapting a workflow for testing of a user interface of an application under test. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 2, an exemplary methodology 200 of adapting a workflow for testing of a user interface of an application under test is illustrated. At 210, a determination is made as to whether adaptive ability is enabled (e.g., based on a setting in the workflow, for a test case in the workflow and/or for a group of test cases in the workflow). If the determination at 210 is NO, at 240, test step(s) are executed, and, no further processing occurs.

If the determination at 210 is YES, at 220, a next child UI element list in a workflow is identified. At 230, a determination is made as to whether the child UI element is available in the user interface of the application under test. If the determination at 230 is YES, at 240, test step(s) associated with testing of the child UI element are executed and no further processing occurs.

If the determination at 230 is NO, at 250, step(s) in the workflow of the test case associated with testing of the child UI element are disabled in the workflow. At 260, a determination is made as to whether there are more elements in the list of elements. If the determination at 260 is YES, process continues at 220. If the determination at 260 is NO, further processing occurs.

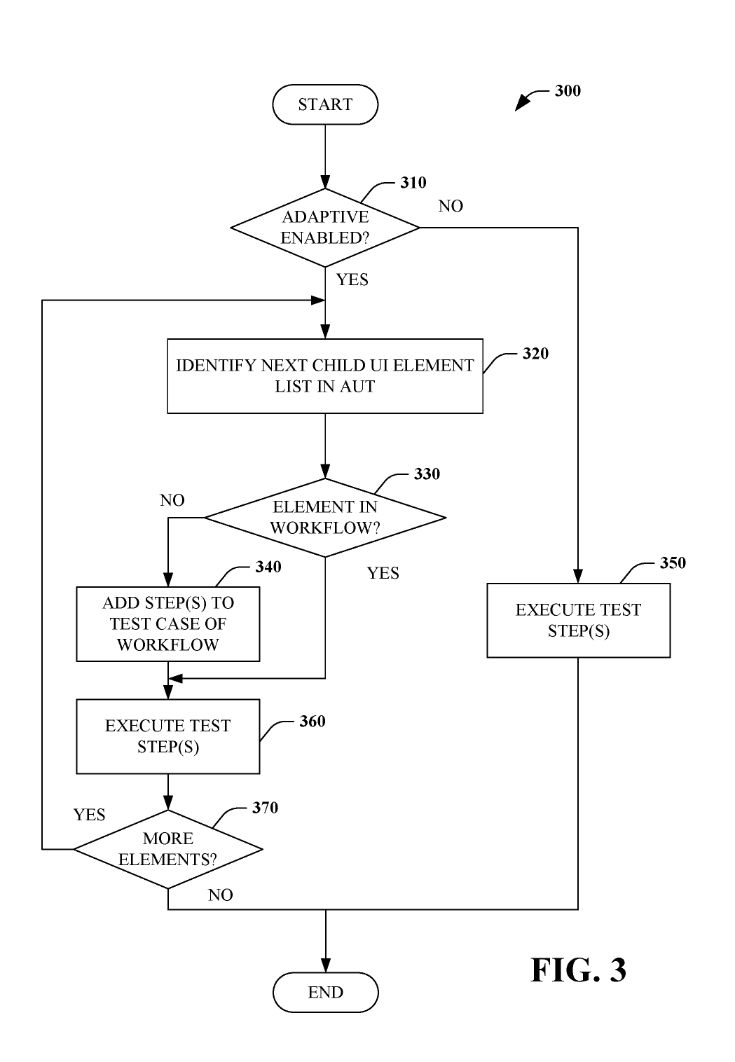

Next, turning to FIG. 3, an exemplary methodology 300 of adapting a workflow for testing of a user interface of an application under test is illustrated. At 310, a determination is made as to whether adaptation is enabled. If the determination at 310 is NO, processing continues at 350.

If the determination at 310 is YES, at 320, a next child UI element list in the user interface of the application under test is identified. At 330, a determination is made as to whether the child UI element exists in the workflow of the application under test. If the determination at 330 is NO, at 340, step(s) are automatically added in the workflow to the test case in order to test the child UI element and processing continues at 360. If the determination at 330 is YES, at 360, test step(s) associated with testing of the child UI element are executed.

At 370, a determination is made as to whether there are more elements in the list of elements. If the determination at 370 is YES, processing continues at 320. If the determination at 370 is NO, no further processing occurs. At 350, test step(s) associated with testing of the child UI element are executed, and, no further processing occurs.

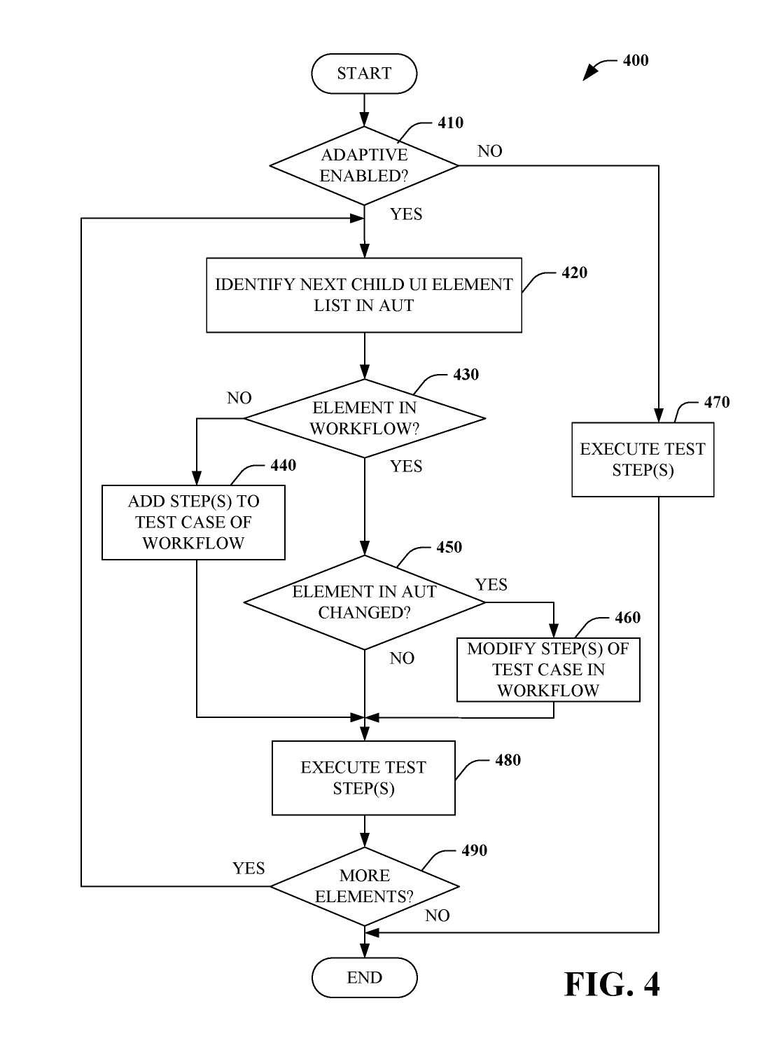

Referring to FIG. 4, an exemplary methodology 400 of adapting a workflow for testing of a user interface of an application under test is illustrated. At 410, a determination is made as to whether adaptation is enabled. If the determination at 410 is NO, processing continues at 470.

If the determination at 410 is YES, at 420, a next child UI element list in the user interface of the application under test is identified. At 430, a determination is made as to whether next the child UI element exists in the workflow. If the determination at 430 is NO, at 440, step(s) are automatically added in the workflow to the test case in order to test the child UI element and processing continues at 480.

If the determination at 430 is YES, at 450, a determination is made as to whether the element in the application under test was modified based on the corresponding element in the workflow. If the determination at 450 is YES, at 460, step(s) are automatically modified in the workflow to the test case in order to test the modified child UI element, and, processing continues at 480. If the determination at 450 is NO, at 480, test step(s) associated with testing of the child UI element are executed.

At 490, a determination is made as to whether there are more elements in the list of elements. If the determination at 490 is YES, processing continues at 420. If the determination at 490 is NO, no further processing occurs. At 470, test step(s) associated with testing of the child UI element are executed and no further processing occurs.

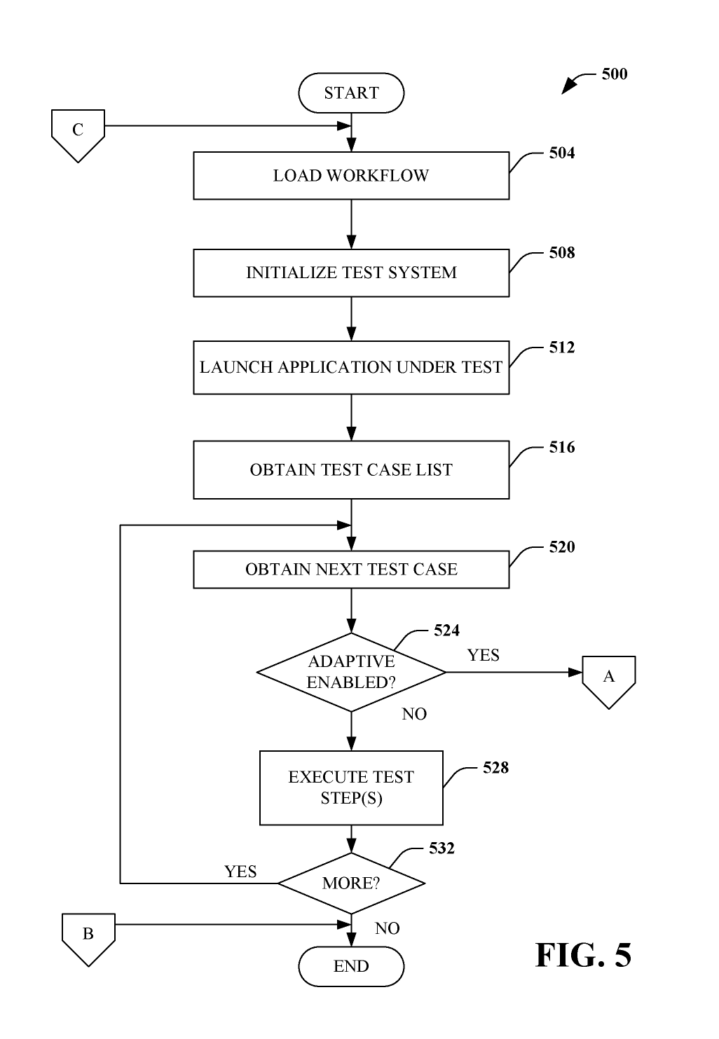

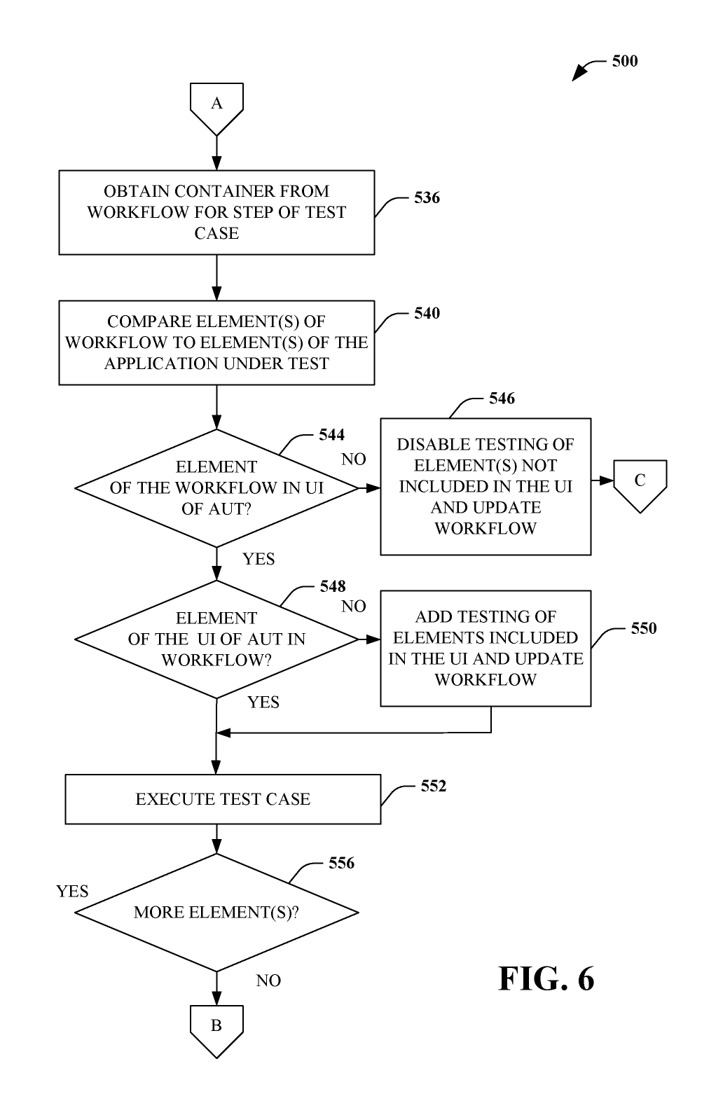

Next, turning to FIGS. 5 and 6, an exemplary methodology 500 of adapting a workflow for testing of a user interface of an application under test is illustrated. At 504, a workflow is loaded.

At 508, the test system is initialized based upon the loaded workflow. For example, the workflow can be parsed, parameter(s) can be parsed and/or environment(s) can be set.

At 512, the application under test is launched. At 516, a test case list is obtained from the workflow. At 520, a next test case is obtained from the workflow. At 524, a determination is made as to whether adaptive ability is enabled. If the determination at 524 is NO, at 528, the test case is executed on the application under test. At 532, a determination is made as to whether there are any more test case(s) in the workflow. If the determination at 532 is YES, processing continues at 520. If the determination at 532 is NO, no further processing occurs.

If the determination at 524 is YES, at 536, a container for the step of the test case is obtained from the workflow. At 540, the workflow is compared to the UI of the application under test. At 544, a determination is made as to whether an element list of the workflow is in the UI of the application under test. If the determination at 544 is NO, at 546, testing of element(s) not included in the UI (e.g., element(s) removed from the UI) can be disabled and the workflow updated accordingly with processing continuing at 504. In one example, a copy of the workflow is cached and updated in addition to the workflow stored in the workflow store 110.

If the determination at 544 is YES, at 548, a determination is made as to whether an element list of the UI of the application under test exists in the workflow. If the determination at 548 is NO, at 550, testing of element(s) included in the UI (e.g., element(s) added to the UI) can be added and the workflow updated according with processing continued at 552.

If the determination at 548 is YES, at 552, the test case is executed. At 556, a determination is made as to whether there are any more elements in the test case. If the determination at 556 is YES, processing continued at 544. If the determination at 556 is NO, no further processing occurs.

Described herein is a system for adapting a workflow for testing of a user interface of an application under test including a processor and a memory, the memory including a playback engine component. The playback engine component includes an initialization component configured to retrieve the workflow from a workflow store and load the application under test. The playback engine further includes an adaptive component configured to identify one or more elements of the user interface of the application under test, compare the one or more elements of the user interface of the application under test to one or more elements specified in the workflow, and based upon the comparison, automatically adaptively update the workflow for testing of the user interface of the application under test. The system can include wherein the adaptive component utilizes an application programming interface of the application under test to identify the one or more elements of the user interface of the application under test.

The system can include wherein automatically adaptively update the workflow for testing of the user interface of the application under test comprises for a user interface element specified in the workflow, but not identified in the one or more user interface elements of the user interface of the application under test, disabling a step of a test case in the workflow. The system can include wherein automatically adaptively update the workflow for testing of the user interface of the application under test comprises for one of the one or more elements of the user interface of the application under test, if the element is not specified in the workflow, automatically adding a step of a test case in the workflow. The system can include wherein automatically adaptively update the workflow for testing of the user interface of the application under test comprises modifying test of an element specified in the workflow.

The system can include an execution component configured to execute a test case specified in the updated workflow. The system can include wherein the execution component executes the test case utilizing an application programming interface of the application under test.

The system can include wherein adaptation of the specified workflow to the one or more elements of the user interface of the application under test is selectively enabled. The system can include wherein adaptation of the specified workflow to the one or more elements of the user interface of the application under test is selectively enabled for one or more steps of a first test case of the specified workflow and selectively disabled for one or more steps of a second test case of the specified workflow.

The system can include wherein the one or more elements of the user interface of the application under test are organized hierarchically and automatically adaptively update the workflow comprises recursively adding test steps to the workflow for child elements.

Described herein is a method for adapting testing of a user interface under test including obtaining information regarding elements of the user interface of the application under test, based upon the obtained information, determining that a first user interface element has been added to the user interface under test; and based upon the determination that the first user interface element has been added, modifying a workflow to add testing of the second user interface element. The method can include wherein obtaining information regarding elements of the user interface of the application under test comprises utilizing an application programming interface of the application under test to identify the elements of the user interface of the application under test. The method can further include based upon the obtained information, determining that a second user interface element has been removed from the user interface under test, based upon the determination that the second user interface element has been removed, modifying the workflow to disable testing of the first user interface element; and executing a test case specified in the modified workflow.

The method can include wherein execution the test case specified in the modified workflow comprises utilizing an application programming interface of the application under test. The method can include wherein the one or more elements of the user interface of the application under test are organized hierarchically. The method can further include automatically adaptively updating the workflow by recursively adding test steps to the workflow for child elements.

Described herein is a computer storage media storing computer-readable instructions that when executed cause a computing device to obtain information regarding elements of the user interface of the application under test, based upon the obtained information, determining that a first user interface element has been added to the user interface under test, based upon the determination that first second user interface element has been added, modifying a workflow to add testing of the second user interface element; and execute a test case specified in the modified workflow. The computer storage media can further include wherein obtain information regarding elements of the user interface of the application under test comprises utilizing an application programming interface of the application under test to identify the elements of the user interface of the application under test. The computer storage media can further include wherein the one or more elements of the user interface of the application under test are organized hierarchically. The computer storage media can further store computer-readable instructions that when executed cause a computing device to automatically adaptively updating the workflow by recursively adding test steps to the workflow for child elements.

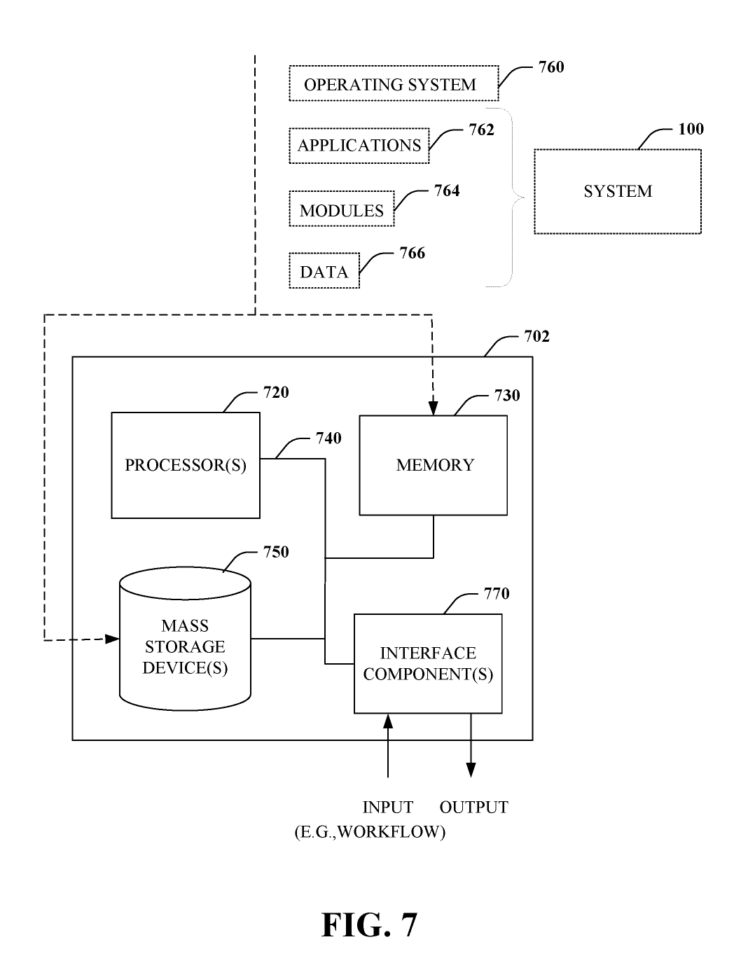

With reference to FIG. 7, illustrated is an example general-purpose computer or computing device 702 (e.g., desktop, laptop, tablet, watch, server, hand-held, programmable consumer or industrial electronics, set-top box, game system, compute node, etc.). For instance, the computing device 702 may be used in a system for adapting a workflow for testing of a user interface of an application under test.

The computer 702 includes one or more processor(s) 720, memory 730, system bus 740, mass storage device(s) 750, and one or more interface components 770. The system bus 740 communicatively couples at least the above system constituents. However, it is to be appreciated that in its simplest form the computer 702 can include one or more processors 720 coupled to memory 730 that execute various computer executable actions, instructions, and or components stored in memory 730. The instructions may be, for instance, instructions for implementing functionality described as being carried out by one or more components discussed above or instructions for implementing one or more of the methods described above.

The processor(s) 720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 720 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 720 can be a graphics processor.

The computer 702 can include or otherwise interact with a variety of computer-readable media to facilitate control of the computer 702 to implement one or more aspects of the claimed subject matter. The computer-readable media can be any available media that can be accessed by the computer 702 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 702. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 730 and mass storage device(s) 750 are examples of computer-readable storage media. Depending on the exact configuration and type of computing device, memory 730 may be volatile (e.g., RAM), non-volatile (e.g., ROM, flash memory, etc.) or some combination of the two. By way of example, the basic input/output system (BIOS), including basic routines to transfer information between elements within the computer 702, such as during start-up, can be stored in nonvolatile memory, while volatile memory can act as external cache memory to facilitate processing by the processor(s) 720, among other things.

Mass storage device(s) 750 includes removable/non-removable, volatile/non-volatile computer storage media for storage of large amounts of data relative to the memory 730. For example, mass storage device(s) 750 includes, but is not limited to, one or more devices such as a magnetic or optical disk drive, floppy disk drive, flash memory, solid-state drive, or memory stick.

Memory 730 and mass storage device(s) 750 can include, or have stored therein, operating system 760, one or more applications 762, one or more program modules 764, and data 766. The operating system 760 acts to control and allocate resources of the computer 702. Applications 762 include one or both of system and application software and can exploit management of resources by the operating system 760 through program modules 764 and data 766 stored in memory 730 and/or mass storage device (s) 750 to perform one or more actions. Accordingly, applications 762 can turn a general-purpose computer 702 into a specialized machine in accordance with the logic provided thereby. In one example, application 762 includes key service component 160.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 762, and include one or more modules 764 and data 766 stored in memory and/or mass storage device(s) 750 whose functionality can be realized when executed by one or more processor(s) 720.

In accordance with one particular embodiment, the processor(s) 720 can correspond to a system on a chip (SOC) or like architecture including, or in other words integrating, both hardware and software on a single integrated circuit substrate. Here, the processor(s) 720 can include one or more processors as well as memory at least similar to processor(s) 720 and memory 730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 702 also includes one or more interface components 770 that are communicatively coupled to the system bus 740 and facilitate interaction with the computer 702. By way of example, the interface component 770 can be a port (e.g., serial, parallel, PCMCIA, USB, FireWire, etc.) or an interface card (e.g., sound, video, etc.) or the like. In one example implementation, the interface component 770 can be embodied as a user input/output interface to enable a user to enter commands and information into the computer 702, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 770 can be embodied as an output peripheral interface to supply output to displays (e.g., LCD, LED, plasma, etc.), speakers, printers, and/or other computers, among other things. Still further yet, the interface component 770 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for adapting a workflow for testing of a user interface of an application under test, comprising:
a processor; and
a memory comprising a playback engine component comprising:
an initialization component configured to retrieve the workflow from a workflow store and load the application under test; and
an adaptive component configured to identify one or more elements of the user interface of the application under test, compare the one or more elements of the user interface of the application under test to one or more elements specified in the workflow, and based upon the comparison, automatically adaptively update the workflow for testing of the user interface of the application under test.

2. The system of claim 1, wherein the adaptive component utilizes an application programming interface of the application under test to identify the one or more elements of the user interface of the application under test.

3. The system of claim 1, wherein automatically adaptively update the workflow for testing of the user interface of the application under test comprises for a user interface element specified in the workflow, but not identified in the one or more user interface elements of the user interface of the application under test, disabling a step of a test case in the workflow.

4. The system of claim 1, wherein automatically adaptively update the workflow for testing of the user interface of the application under test comprises for one of the one or more elements of the user interface of the application under test, if the element is not specified in the workflow, automatically adding a step of a test case in the workflow.

5. The system of claim 1, wherein automatically adaptively update the workflow for testing of the user interface of the application under test comprises modifying test of an element specified in the workflow.

6. The system of claim 1, further comprising an execution component configured to execute a test case specified in the updated workflow.

7. The system of claim 6, wherein the execution component executes the test case utilizing an application programming interface of the application under test.

8. The system of claim 1, wherein adaptation of the specified workflow to the one or more elements of the user interface of the application under test is selectively enabled.

9. The system of claim 1, wherein adaptation of the specified workflow to the one or more elements of the user interface of the application under test is selectively enabled for one or more steps of a first test case of the specified workflow and selectively disabled for one or more steps of a second test case of the specified workflow.

10. The system of claim 1, wherein the one or more elements of the user interface of the application under test are organized hierarchically and automatically adaptively update the workflow comprises recursively adding test steps to the workflow for child elements.

11. A method for adapting testing of a user interface under test, comprising:
obtaining information regarding elements of the user interface of the application under test;
based upon the obtained information, determining that a first user interface element has been added to the user interface under test; and
based upon the determination that the first user interface element has been added, modifying a workflow to add testing of the second user interface element.

12. The method of claim 11, wherein obtaining information regarding elements of the user interface of the application under test comprises utilizing an application programming interface of the application under test to identify the elements of the user interface of the application under test.

13. The method of claim 11, further comprising:
based upon the obtained information, determining that a second user interface element has been removed from the user interface under test;
based upon the determination that the second user interface element has been removed, modifying the workflow to disable testing of the first user interface element; and
executing a test case specified in the modified workflow.

14. The method of claim 11, wherein execution the test case specified in the modified workflow comprises utilizing an application programming interface of the application under test.

15. The method of claim 11, wherein the one or more elements of the user interface of the application under test are organized hierarchically.

16. The method of claim 15, further comprising automatically adaptively updating the workflow by recursively adding test steps to the workflow for child elements.

17. A computer storage media storing computer-readable instructions that when executed cause a computing device to:
obtain information regarding elements of the user interface of the application under test;
based upon the obtained information, determining that a first user interface element has been added to the user interface under test;
based upon the determination that first second user interface element has been added, modifying a workflow to add testing of the second user interface element; and
execute a test case specified in the modified workflow.

18. The computer storage media of claim 17, wherein obtain information regarding elements of the user interface of the application under test comprises utilizing an application programming interface of the application under test to identify the elements of the user interface of the application under test.

19. The computer storage media of claim 17, wherein the one or more elements of the user interface of the application under test are organized hierarchically.

20. The computer storage media of claim 19, further storing computer-readable instructions that when executed cause a computing device to automatically adaptively updating the workflow by recursively adding test steps to the workflow for child elements.
